(19) United States
(12) Patent Application Publication
(10) Pub. No.: US 2003/0235413 A1
(43) Pub. Date: Dec. 25, 2003

(54) Data processing using polarization-based optical switching and broadcasting

(76) Inventors: Nadav Cohen, Tel-Aviv (IL); Bruce Leibner, Ramat-Gan (IL); Emmanuel Marom, Tel-Aviv (IL); David Mendlovic, Petach-Tikva (IL); Zeev Zalevsky, Rosh-Haayin (IL); Naim Konforti, Holon (IL)

Correspondence Address: William H Dippert, Reed Smith, 29th Floor, 599 Lexington Avenue, New York, NY, 10022-7650, US

(21) Appl. No.: 10/343,177

(22) PCT Filed: Jul. 19, 2001
(86) PCT No.: PCT/IL01/00668

(51) Int. Cl. H04J 14/00

(52) U.S. Cl. 398/43

(57) ABSTRACT

An optical method and system are presented utilizing a 2×2 broadcast switch device for performing various logical operations, such as neural network, logical gates, as well as performing analog to-digital conversion, and interferometric testing. The switch device is of the kind performing polarization coding of light passing therethrough.

### FIELD OF THE INVENTION

This invention is generally in the field of optical communication techniques, and relates to a method and device for data processing and transmitting using all-optical switching and broadcasting.

### BACKGROUND OF THE INVENTION

Optical communication networks require switching mechanisms enabling direction, diversion, multiplexing or broadcasting (multicasting) of a plurality of information channels in a manner to meet the requirement of the network. Many telecommunication applications require the capability to switch any signal in an input array of N signals to one output signal in an array of M output signals. To carry out this function, telecommunication switching, transport and routing systems often utilize multistage interconnection networks MIN), which are alternating layers of fixed interconnection patterns and arrays of basic switching modules (typically for two signals, called bypass-exchange switches), each layer of interconnection links and switch arrays presenting a stage.

MINs have been proposed and utilized for computer architecture and telephone switches (where the signals are electronic), and are capable of performing dynamic interconnections between a source point and a target point by varying the settings of the switches. MIN systems usually use small switches (2×2 or 4×4 are the common cases) to achieve larger switching systems. The smaller switches are combined in a special architecture defined by the specific MIN used, and are interconnected by a static pattern.

Traditional approaches to designing the elementary bypass-exchange switch for optical signals include building a hybrid opto-electronic semiconductor circuit employing photodetectors, electronic circuitry for switching and lasers or optical modulators. Optical signals are converted to electric signals, which, after amplification and electronic switching, are used to drive the lasers. The disadvantages of this process include low efficiency, high cost, complexity, and low reliability due to noise factors introduced and confinement to sub-gigabit modulation rates.

A bypass-exchange switch (also known as 2×2 switch) is an element containing two input channels and two output channels. In this element, each output channel is connected to a single input channel. The two possible connection schemes are called “bypass-mode” and “exchange-mode”. FIGS. 1A and 1B illustrate 2×2 switch elements utilizing these two connection schemes, respectively.

A 2×2 switch may be enhanced by the addition of a broadcast capability, i.e., the ability to distribute the energy from any of the input channels to more than one of the output channels. A broadcast-enhanced 2×2 switch has at least two additional switch states called, respectively, “upper-broadcast mode” and “lower-broadcast mode”. FIGS. 2A and 2B illustrate broadcast-enhanced 2×2 switches utilizing these modes, respectively.

Larger switches may be easily constructed. Several conventional all optical switch designs have been developed. Some of them are based on the crossbar architecture, and are disclosed for example in the following publications:

(1) A. A. Sawchuck, B. K. Jenkins, C. S. Raghavendra and A. Varma, “Optical crossbar network”, Computer 20 (6), 50 (1987);

(2) D. O. Harris, “Multichannel acousto-optic crossbar switch”, Appl. Opt., Vol. 33, 1734-1741, 1994;

(3) H. Yamazaki and S. Fukushima, “Holographic switch with a ferroelectric liquid-crystal spatial light modulator for a large scale switch”, Appl. Opt., Vol. 34, 8137-8143, 1995;

(4) A. A. Dias, R. F. Kalman, J. W Goodman and A. A. Sawchuck, “Fiber optic crossbar switch with broadcast capabilities”, Opt. Eng. 27, 955 (1988); and

(5) Y. Wu, L. Liu and Z. Wang “Optical crossbar elements used for switching networks”, Appl. Opt., Vol. 33, 175-178, 1994.

As described in the publications (1) and (5), optical broadcasting switches can be used mainly in crossbar implementations and in Clos networks which use crossbar switches as sub-elements.

All optical switch designs of the kind based on the three stage (or five) Clos network are disclosed in the following publications:

(6) S-H. Lin, T. F. Krille and J. Walkup, “Two-dimensional optical Clos interconnection network and it's uses”, Appl. Opt., Vol. 27, 1734-1741, 1988; and

(7) M. Hossain, S. Ghanta and M. Guizani, “Optical realization of a Clos nonblocking broadcast switching network with constant time network control algorithm”, Appl. Opt., Vol. 32, 665-673, 1993.

All optical switch designs of the kind based on Multistage Interconnection Network (MIN) Delta architectures, such as Omega, Banyan, Cantor and others, are disclosed, for example, in the following publications:

(8) K. Hogari, K. Noguchi and T. Matsumoto, “Two-dimensional multichannel optical switch”, Appl. Opt., Vol. 30, 3277-3278, 1991;

(9) K. M. Johnson, M. R. Surette and J. Shamir, “Optical interconnection network using polarization based ferroelectric liquid-crystal”, Appl. Opt., Vol. 27, 1727-1733, 1988;

(10) N. Wang, L. Liu and Y Yim, “Cantor network, control algorithm, two-dimensional compact structure and it's optical implementation”, Appl. Opt., Vol. 34, 8176-8181, 1995;

(11) D. Marom and D. Mendlovic, “Compact all optical bypass exchange switch”, Appl. Opt., Vol. 35, 248-253, 1996; and

(12) D. Marom and D. Mendlovic “All-optical reduced state 4 by 4 switch”, Optics and Photonics News 7, 43, 1996.

MIN optical switches utilizing the 2×2 switch as a basic switching element are also disclosed, for example, in the following publications:

(13) T. Stone and J. M. Battiato, “Optical array generation and interconnection using birefringent slabs”, Appl. Opt., Vol. 33, 182-190, 1994; and

(14) J. E. Midwinter, “Photonics in Switching”, Vols. 1 and 2, Academic press, 1993.

The design of a switching element described in the publications (10)-(14), is based on a controlled λ/2 plate placed in between two birefringent calcite crystals that act as beam displacement plates (BDP). This approach has been demonstrated in the publications (12) and (13) for 2×2 and for 4×4 optical switches.

Lately, the inventors of the present application have developed an implementation of a broadcast-enhanced 2×2 switch, which is disclosed in the following publication:

(15) D. Mendlovic, B. Leinber, N. Cohen, “Multistage Optical System for Broadcasting and Switching Information”, Appl. Opt., Vol. 58, Issue 29.

The switching element described in (15) can be used for constructing broadcast MINs with relatively high light efficiency, easy alignment, diminished number of active cells (for large-scale systems), as compared to crossbar implementation and enables homogeneous intensity distribution among broadcasted outputs. This switching element may replace the conventional 2×2 switch in a MIN system, and allows for using randomly polarized input light. This switching element utilizes polarization coded inputs that are dynamically controlled by electrically addressed retarders. Such a switching element is also disclosed in U.S. Pat. No. 6,041,151.

FIG. 3 illustrates the basic structure of such a 2×2 bypass exchange switch based on polarization coding using Bifringent calcite crystals as BDPs and a λ/2 Ferroelectric Liquid-Crystal (FLC) retarder switch. In this system, two input signals A and B are orthogonally polarized (for example by using a λ/2 plate in the entrance plane of signal B). The input signals A and B are combined by the calcite BDP1, driven through a controlled λ/2 FLC pixel, and reopened by the second calcite BDP2. When the proper voltage is applied to the FLC pixel, it acts as a λ/2 pixel, and the polarizations of signals A and B interchange, thus achieving an exchanged state of the inputs in the output plane. Otherwise, the FLC is “transparent” to the input signals, and the output is identical to the input (bypass mode). The last λ/2 plate in the output plane adjusts the output polarization of the second beam.

FIG. 4 illustrates the use of a similar approach to obtain a 2×2 broadcast switch. By replacing the controlled λ/2 FLC pixel in between the two calcites with a more sophisticated retarder that allows the retardation level to be controlled in fine steps, the four basic states of the broadcast switch (shown in FIGS. 1A-1B and 2A-2B) is obtained, while allowing even greater flexibility. The bypass and exchange modes are received by activating the retarder to, respectively, 0 and λ/2 phase differences between the retarder's orthogonal axes. The two broadcasting modes are achieved by activating the retarder to retardation of λ/4, and blocking (not shown) one of the inputs (signal B for upper broadcast mode, and signal A for lower broadcast mode). By limiting the system to the use of these four modes, an important property of the switching system is achieved: the division of the broadcasted input signal into two energy-equivalent output signals.

### SUMMARY OF THE INVENTION

The present invention provides for various data processing and transmitting aspects, which are implemented using an optical switch and broadcasting devices based on the polarization encoding of information. Such devices include, for example, fiber insertion devices, logical gates, neural networks, clock distributors, spatial vector to matrix multipliers, add/drop multiplexors, adaptive analog-to-digital (A/D) devices, miniature interferometers and image subtractors. The implementation of logical gates is an important request in many fields such as cryptography. Actually, the logical gates are essential components in most of the VLSI circuits.

In order to implement such logical operations, the present invention utilizes the broadcast feature of one or more switch device. Such a switch device with the broadcast feature is characterized by the controllable energy distribution of two input beams (retardation level coefficients for two input beams), defined by the operation of a controllable polarization rotating medium.

Thus, according to one aspect of the present invention, there is provided an optical method of performing at least one of the following functions: logical operations, clock distribution, add drop multiplexing, and vector-matrix multiplying, the method comprising passage of at least one input signal through a predetermined number of 2×2 broadcast switch devices, each operable to perform polarization encoding of light passing therethrough and comprising a controllable polarization rotating medium operable to provide a predetermined energy partition of two beam components passing therethrougb, to thereby obtain an output signal of the switch device in the form of a sum of energies of the two beam components according to the predetermined energy partition.

In order to selectively realize one of the following logical gates: OR, AND, NAND, and NOR, one or two input beams are selectively supplied to the switch device, and the output of the switch device passes through a thresholding utility preprogrammed to a certain threshold value in accordance with the logical gate to be realized.

In order to perform the neural network logical operation, M input signals are supplied from N couplers, appropriately coupled to the switch devices. By this, a plurality of the output signals are produced, each of said output signals being a sum of energies of all the inputs according to the predetermined energy partitions of the respective nodes. These output signals are directed to a plurality of thresholding utilities, respectively. Each thresholding utility is preprogrammed to a certain threshold value to thereby selectively allow collection of the respective output signal at an output port.

In order to perform the clock distribution of the input signal to a predetermined number N of locations, the input signal is directed to propagate along N various circuits. To this end, the input signal passes through the switch devices arranged in a tree-like cascade manner, enabling multiple switching stages defining these N various circuits. A frequency v of the input signal is selected to satisfy a relationship ν>(c/Δd), wherein c is the light velocity, and Δd is a maximal difference between locations of said circuits enabling simultaneous arrival of the input signal at said N locations, and is determined as follows: Δd=max{d₁, d₂, . . . , d_{N}}−min{d₁, d₂, . . . , d_{N}}, wherein d₁, d₂, . . . , d_{N} are lengths of the N circuits.

In order to perform the add drop multiplexing, the input signal, which is a multiple wavelength signal, passes through a first switch device producing first and second output signals with a predetermined energy partition therein propagating along two output channels of the first switch device. The first and second output signals of the first switch device pass through, respectively, first and second frequency filters producing first and second filtered signals, the first filtered signal propagating towards a drop channel. The second filtered signal and a signal supplied from an add channel pass through a second switch device producing an output signal propagating towards a pass channel.

In order to perform the vector matrix multiplying operation, the input signal to be processed is a spatial vector having no more than two signals A and B. This input signal is simultaneously coupled to N modules, each including said switch device. The switch devices are characterized by pairs of coefficients a₁ and b₁; a₂ and b₂; . . . ; a_{N} and b_{N}, respectively. By this, 1×2 with 2×N vector with matrix multiplication is obtained. By passing the input beam through M sets of the N modules, M 1×2 with 2×N vector with matrix multiplication can be obtained.

According to other aspects of the present invention, there is provided an optical system for performing one of the above-mentioned logical operations.

According to yet another aspects of the invention, there are provided optical methods and systems for performing interferometric testing of an object, and an adaptive analog to digital conversion of an input signal.

Polarization based processing (switching or other) requires linearly polarized input beams. It is often the case in optical communication systems that light entering the switch is fed from fibers (that do not always preserve polarization). In such cases, it is desirable to set the polarization to the required state. The simplest known way to achieve a linearly polarized beam from a randomly polarized one is to use a polarizer in the input. This method is very inefficient in terms of energy. In the extreme case, where the switch input polarization is in orthogonal to the required one, the polarizer would block the beam completely. A known technique for obtaining the required linear polarization, while preserving nearly 100% of the energy, utilizes the passage of collimated input through a calcite that separates the input beam to two beam components of different polarizations, which then pass through an FLC panel, where the polarization of one of them remains unchanged, while the polarization of the other beam is 90° rotated. By this, both parts of the beam become polarized in the same direction, and are then treaded as one beam. The price paid is an increased space-bandwidth-product (SBP). If merging of the two sub-beams into a single beam is required, it is possible to place the input beams further apart (say on a farther FLC pixel), and then to perform slightly defocused imaging.

A similar problem exists when trying to re-enter a processed signal into an optical fiber. This problem is associated with the following. First, the increased SBP may be inconvenient. Second, and more important is that, in many cases, it may be required that the input polarization to the fiber be randomized.

The present invention, according to one broad aspect thereof, provides a switching method and device aimed at solving this problem of inserting light into fibers. Information contained in a “fiber tube” that is linearly polarized is re-adjusted to the original dimensions, thus restoring at lease some of the random polarization that existed at the entry point to the system. This is implemented by directing two input beams supplied from two fiber tubes, respectively, and being linearly polarized in the same direction onto an FLC panel (or other λ/2 retardation means), thereby dividing each of the two input beams into two beam components of different polarizations. These two pairs of beam components then impinge onto a common birefringent element (e.g., calcite), or separate birefringent elements, affecting the direction of the beams' propagation such that two output beams of random polarization are produced propagating towards two fibers, respectively.

There is thus provided according to yet another aspect of the invention, a method for processing two input light beams linearly polarized in the same direction to provide two output beams of random polarization propagating towards two output channels, respectively, the method comprising the steps of

applying a 90-degree polarization rotation to a beam component of each of the input beams, thereby producing two pairs of beam components, wherein the beam components of each pair have different linear polarizations;

passing the two pairs of beam components through a birefringent medium capable of affecting a direction of propagation of at least one beam component of each pair, thereby obtaining the two output beams of random polarization.

An optical device for carrying out the above method comprises means for spatially separating each of the input beams into a pair of beam components; a polarization rotating means performing a 90-degree polarization rotation of one beam component of each pair; and a birefringent medium affecting the direction of propagation of at least one beam component of each pair.

Preferably, the means for spatial separation of each of the input beams and the polarization rotating means are incorporated in a common ferroelectric liquid crystal unit defining an array of separately controllable cells.

There is also provided a method for connecting two input channels supplying input light beams of random polarization to two output channels for conducting light beams of random polarization, the method comprising the steps of:

passing the input beams through a first birefringent medium capable of affecting the direction of propagation of at least one polarization component of each of the input beams, thereby producing two pairs of beam components, the two beam components in each pair being of different linear polarizations;

passing the beam components through a first polarization rotating means operable to perform 90-degree polarization rotation of one beam component of each pair of beam components, thereby producing two light beams linearly polarized in the same direction;

passing said two light beams linearly polarized in the same direction through a 2×2 switching element operable to perform polarization encoding of light passing therethrough;

passing two light beams linearly polarized in the same direction as output from said 2×2 switch device through a second polarization rotating means operable to perform 90-degree polarization rotation of one beam component of each of said beams; and

passing the beam components, that have passed through said second polarization rotating means, through a second birefringent medium affecting the direction of propagation of at least one polarization component of each of said beams, thereby producing two light beams of random polarization propagating towards said two output channels, respectively.

A switch device for carrying out the above method comprises an input optical setup including said first birefringent medium and said first polarization rotating means; an output optical setup including said second polarization rotating means and said second birefringent medium; and a 2×2 switching element accommodated between the input and output setups and operable to perform polarization encoding of light passing therethrough.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A and 1B are prior art 2×2 switch elements utilizing, respectively, bypass and exchange connection schemes;

FIGS. 2A and 2B are prior art broadcast-enhances 2×2 switches utilizing, respectively, upper-broadcast and lower-broadcast modes;

FIGS. 3 illustrates the prior art basic structure of a 2×2 bypass exchange switch based on polarization coding using BDPs and a λ/2 Ferroelectric Liquid-Crystal (FLC) retarder switch;

FIG. 4 illustrates the prior art 2×2 broadcast switch based on polarization coding;

FIG. 5 illustrates a generalized 2×2 broadcasting and switching system utilizing the 2×2 bypass-exchange switch device;

FIG. 6 illustrates an optical system according to the invention for inserting two beams linearly polarized in the same direction into fibers conducting light of random polarization;

FIG. 7 illustrates a switch device according to the invention;

FIG. 8 illustrates an optical system according to the invention for performing such logical operations as gates OR, AND, NAND, NOR;

FIG. 9 illustrates an optical system according to the invention for performing such a logical operation as neural network;

FIG. 10 illustrates an optical system according to the invention operable as a clock distributor;

FIGS. 11A and 11B illustrate two different examples of an optical system according to the invention operable as a vector-matrix-multiplier;

FIG. 12 illustrates an optical system according to the invention operable as an add drop multiplexer;

FIGS. 13A and 13B illustrate two different examples of an optical system according to the invention operable as an adaptive analog-to-digital converter;

FIG. 14 illustrates an optical system according to the invention operable as an interferometer.

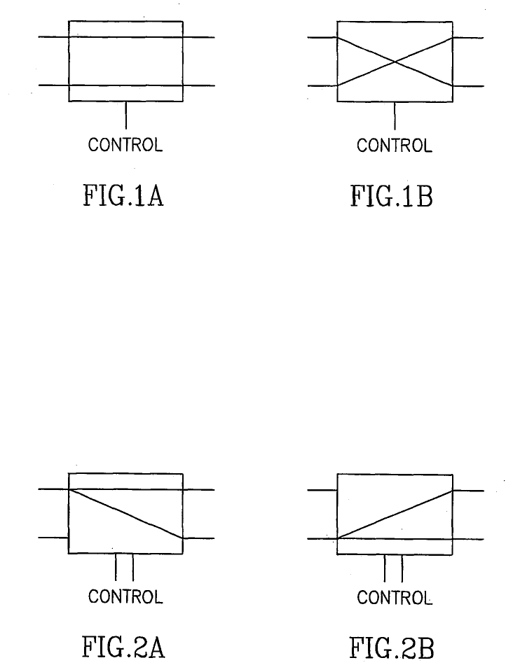

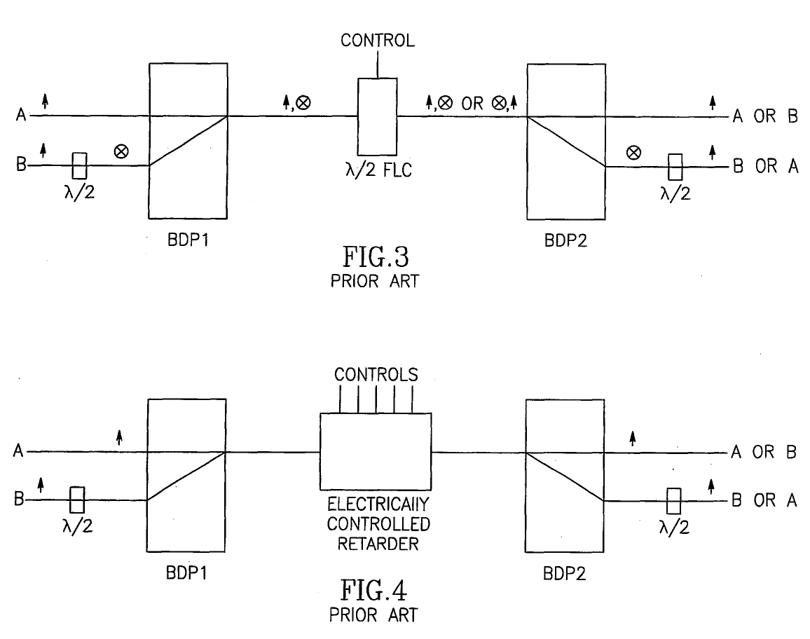

### DETAILED DESCRIPTION OF THE INVENTION

In MIN systems consisting of several 2×2 broadcast switches (FIG. 4), the broadcast state in the proper switches can be activated to divide the energy of the input signal among the connected outputs evenly (for an even pair of outputs). In the more general case, both inputs are always connected to the switch, and the multicast level (i.e., the input ports energy distribution between the output ports) is arbitrary.

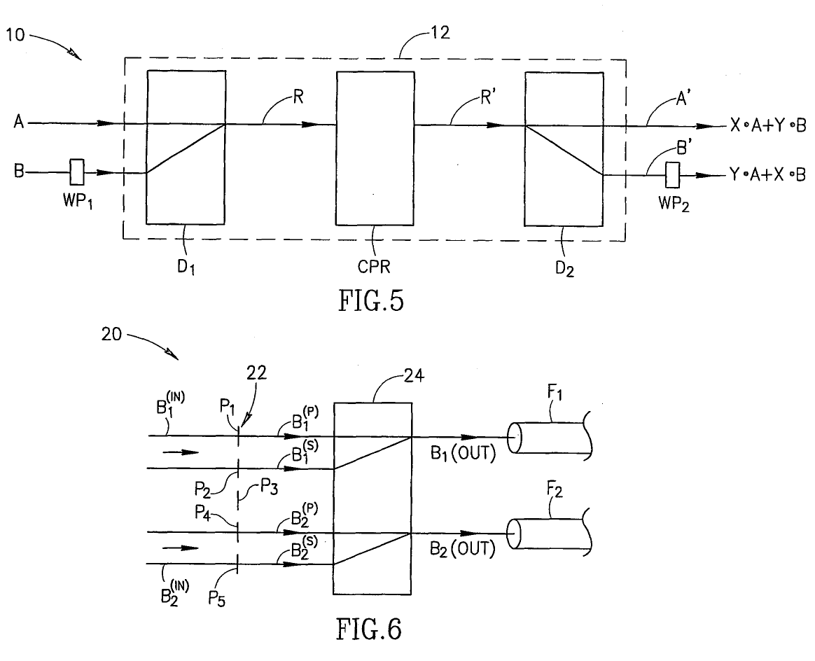

FIG. 5 illustrates a generalized 2×2 broadcasting and switching system 10 utilizing a 2×2 bypass-exchange switch device 12 that may be used as a basic block in various optical systems according to the invention. It should be noted that the present invention refers to any incoherent input signals (e.g., obtained by using different wavelengths generated by a single source or separated sources) with any polarization, including unpolarized signal, providing an appropriate switching device 12 (as will be described below) is used. In the present example, the switch device 12 is constructed similar to that disclosed in the above-indicated publication (15), wherein input light has a specific polarization. It should, however, be noted that any other suitable design of a 2×2 switch with the broadcast feature can be used, for example such as the Photon XX switch commercially available from Lynx Photonics (wherein input light is of random polarization), and PolarShift™ commercially available from Chorum Technologies.

Here, X and Y are dependant, and reflect a retardation level (when considering polarization-based switches). If X and Y are to be set to independent levels, an additional attenuator should be used in the optical path of one of the signals. The ratio between X and Y is, however, independent. Hence, if arbitrary values of X and Y are required, the switch device sets the appropriate ratio, and an additional amplifier is used. If X=1 and Y=0, by-pass feature is realized; if X=0 and Y=1, the exchange feature is realized; and X=0.5 and Y=0.5, the device performs one possible mode of broadcasting.

Thus, the device 10 comprises two polarizing beam displacers D₁ and D₂ (e.g., Calcite crystals) capable of combining and splitting two input beams A and B; and a controllable polarization rotator CPR capable of performing different phase delays in the range of 0-λ/2 between its two principle axes and performing the switching function. The CPR has a plurality of active states and a passive state, determined by a control signal, and may be any medium that dynamically affects the polarization of incident light either in response to the application of an electric field (“activated state”) or not (“inactivated state”), e.g., a ferroelectric liquid crystal (FLC) cell. The polarizing beam displacer presents a birefringent medium capable of affecting the direction of propagation of at least one of the input beams, so as to appropriately displace this beam, thereby combining the two beams into an output beam of random polarization.

In the present example of polarization based switch 12, the two input signals A and B must be linearly polarized in the orthogonal directions before being input to the bypass-exchange switch device 12. To this end, assuming the two signals enter at the same polarization, a half wave plate WP₁ is provided in the optical path of input beam B to orient the polarization state of said beam. Thus, input B propagates through the fixed half wave plate WP₁ and is converted to a linearly polarized beam B′ rotated 90 degrees. Both signals are incident on the displacer D₁ of a length providing a displacement of beam B that equals the distance between the input beam A and B, guaranteeing that both signals emerge as one ray R with two orthogonal polarizations representing signals A and B. Signal R then passes through the controllable half wave gate WG, which is shiftable between its inoperative and operative modes, determined by a control signal. If the CPR is in the operative mode, the two orthogonal polarizations undergo 90-degree rotation, with signals A and B exchanging their polarizations. If the CPR is in the inoperative mode, the two orthogonal polarizations do not undergo any rotation. A resultant signal R′ is then split by the displacer D₂ into signals A′ and B′. The polarization of signal B′ is then converted back to its original polarization, by passing the beam B′ through the half wave plate WP₂, for consistency with the input polarization state (since bypass-exchange switch 12 may be employed in a multistage switch).

Referring to FIG. 6, there is illustrated an optical system 20 for processing two input beams B⁽ⁱⁿ⁾₁ and B⁽ⁱⁿ⁾₂ linearly polarized in the same direction supplied from a system (not shown) of the kind providing two linearly polarized beams, in order to produce two output signals B₁^{(out)}₁ and B₂^{(out)} of random polarization for entering two fibers F₁ and F₂, respectively. The system 20 can thus be used to arrange random polarization of the information after being switched and processed in the free space. Such polarization distortion is required since, if polarized information is inserted into the fiber, undesired interference will occur.

The system 20 comprises an FLC panel 22 (which can be a constant half wave plate) and a calcite polarizing displacer 24. The FLC panel 22 presents a medium capable of spatially separating each of the input beams B⁽ⁱⁿ⁾₁ and B⁽ⁱⁿ⁾₂ into a pair of beam components, and is operable to affect (rotate) the polarization of one of the beam components. The beams' propagation is shown here schematically to simplify the illustration.

As shown, the FLC panel contains an array of spaced apart pixels, five such pixels P₁-P₅ being shown in the present example, wherein one pair of pixels P₁-P₂ is accommodated in the optical path of the input beam B⁽ⁱⁿ⁾₁, and another pair of pixels P₄-P₅ is accommodated in the optical path of the other input beam B⁽ⁱⁿ⁾₂. One pixel in each pair is in its operative mode (i.e., perform a 90-degree rotation of the polarization of an incident beam component), and the other pixel is in its inoperative mode (i.e., does not affect the polarization of an incident beam component). In the present example, pixels P₂ and P₅ are in the operative modes.

Thus, the input beams B⁽ⁱⁿ⁾₁ and B⁽ⁱⁿ⁾₂ impinge onto the FLC plane 22, and, after passing therethrough, are divided into pairs of beam components B^{(p)}₁-B^{(s)}₁ and B^{(p)}₂-B^{(s)}₂, respectively, which impinge onto the displacer 24. The directions of propagation of beam components B^{(p)}₁ and B^{(p)}₂ inside the displacer 24 remain unchanged, while beam components B^{(s)}₁ and B^{(s)}₂ are appropriately displaced. By this two output beams B^{(out)}₁ and B^{(out)}₂ of random polarization are produced propagating towards the output fibers. It should be understood that, if input beams B⁽ⁱⁿ⁾₁ and B⁽ⁱⁿ⁾₂ have different linear polarizations, the FLC pixels will be operated appropriately in order to achieve the required orthogonal polarizations.

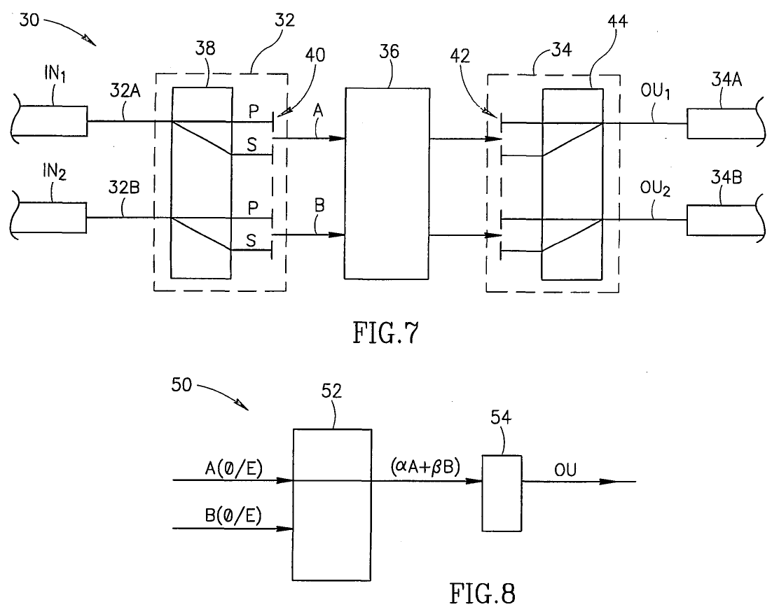

FIG. 7 illustrates a 2×2 optical switch device 30 to be utilized in a node, which is interconnected between two input channels IN₁ and IN₂ (fibers) supplying signals 32A and 32B, respectively, of unpolarized light, and two output channels OU₁ and OU₂ (fibers) for conducting unpolarized signals 34A and 34B. The device 30 comprises a basic 2×2 bypass-exchange switch device 36 (for example constructed as the above described device 12); an input optical setup 32 for processing light from the two unpolarized inputs to produce two beam pairs of linear polarization in the same direction to enter the device 36; and an output optical setup 34 for processing beams linearly polarized in the same direction as ensuing from the device 36 to produce the two outputs of random polarizations.

The input optical setup 32 comprises a calcite 38 and a FLC panel 40. Each of the input beams 32A and 32B is divided by the calcite 38 into two beam components of different linear polarizations. Operative pixels of the FLC panel 40 rotate the polarization of respective beam components, thereby producing beam pairs A and B linearly polarized in the same direction inputting the device 36 which is, for example, a polarization based switch like device 10 of FIG. 5. The output optical setup 34 is constructed similar to the setup 20 of FIG. 6, namely comprising an FLC panel 42 and a calcite polarizing displacer 44.

According to the present invention, the 2×2 switch device 30 of FIG. 7 or switch device 12 of FIG. 5 (as the case may be) is used as a powerful basic element for various data processing implementations, such as logical gates, neural networks, clock distributor, spatial vector-matrix multiplier, add/drop multiplexer, analog-to-digital converter, and interferometer as described hereinbelow

Logical Gates

The present invention utilizes the broadcast feature of a switch device in order to implement logical operations. As shown in FIG. 8, in an optical system 50, two input signals A and B of a known energy are supplied to an optical switch device 52, and an output signal of the device, being the sum (αA+βB), passes through a threshold filter 54 (composed of a detector and comparator) to produce an output signal OS of the entire system 50. The optical switch device 52 may be constructed as any 2×2 optical bypass-exchange switch, for example, as the above described device 30, device 12 of the publication (15) or the Photon XX commercially available from Lynx PN. Coefficients α and β correspond to the energy partition in the device 52 (i.e., its multicast function) with respect to two input channels, respectively, and are defined by control signals applied to a controllable polarization rotating medium (CPR in FIG. 7), thereby determining the energy partition inside the switch device 52. The input energy supplied to input channels (beams A and B) may be 0×E or 1×E, wherein E is the energy. By appropriately setting the threshold value TH and the energy partition in the switch device 52 (coefficients α and β), one of the following logical functions (gates) can be realized: OR, AND, NOR, or NAND. Comparing the optically obtained result (output of the device 52) with the threshold, a desired logical gate is realized. It should be noted that implementation of either NOR gate or a NAND is sufficient to implement any logic operation.

Here, the device 52 is operated to set the coefficients α=β=0.5, thereby providing the output signal of (0.5A+0.5B). Hence, for all possible combinations of the input energy (namely, A=B=0; A=1 and B=0; A=0 and B=1; and A=B=1), depending on the set threshold value, the following will occur:

If the threshold value is set to satisfy the condition TH>0.25E, the logical gate OR is realized;

If the threshold satisfies the condition TH<0.25E, the logical gate NOR is realized;

If the threshold satisfies the condition TH>0.75E, the logical gate AND is realized; and

If the threshold satisfies the condition TH<0.75, the logical gate NAND is realized.

The energy partition will be generally called here as the “A+B” option. The comparison of the sum signal (αA+βB) with a threshold value is the basic module of a neural network configuration. Since the required values of the coefficients α and β can be easily obtained with the “A+B” option of the above-described system 50, such a system could be the cornerstone in building an optical neural network.

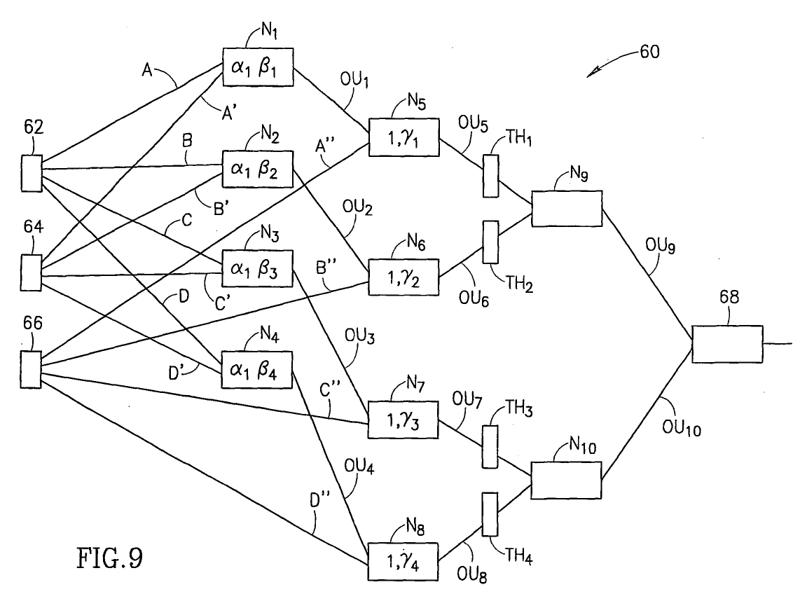

FIG. 9 illustrates an example for the optical implementation of a certain neural network, generally at 60, according to the invention. In the present example, the neural network provides for making decisions based on the states of the three input couples 62, 64 and 66, resulting in an output port 68 through a plurality of nodes and a plurality of threshold filters, ten nodes N₁-N₁₀ and four threshold filters TH₁-TM₄ in the present example. Each node includes the above-described device 52 and is characterized by respective coefficients defining the energy partition thereinside, being thereby capable of performing weighted sum of the respective inputs. The system 60 operates in the following manner.

Input couple 62 supplies input signals A, B, C and D directed to the nodes N₁, N₂, N₃ and N₄, respectively; input couple 64 supplies input signals A′, B′, C′ and D′; directed to the nodes N₁, N₂, N₃ and N₄; and input couple 66 supplies input signals A″, B″, C″ and D″ directed to the nodes N₅, N₆, N₇ and N₈. The nodes N₁-N₄ produce outputs OU₁-OU₄ in the form of sums (α₁A+β₁A′), (α₂B+β₂B′), (α₃C+β₃C′), and (α₄D+β₄D′), respectively; and nodes N₅-N₈ produce outputs OU₅-OU₈ in the form of sums (α₁A+β₁A′+γ₁A″), (α₂B+β₂B′+γ₂B″), (α₃C+β₃C′+γ₃C″), and (α₄D+β₄D′+γ₄D″), respectively. Outputs OU₅ and OU₆ are connected to the node N₉ through the threshold filters TH₁ and TH₂, respectively; and outputs OU₇ and OU₈ are connected to the node N₁₀ through the threshold filters TH₁ and TH₂. Thus, depending on the set threshold values and coefficients, each of the nodes N₉ and N₁₀ may and may not be operated to process incoming signals. If operated, the nodes N₉ and N₁₀ produce output signals OU₉ and OU₁₀, respectively, propagating to the output port 68. Thus, depending on the threshold values, a required output is produced at output port 68.

Clock Distributor

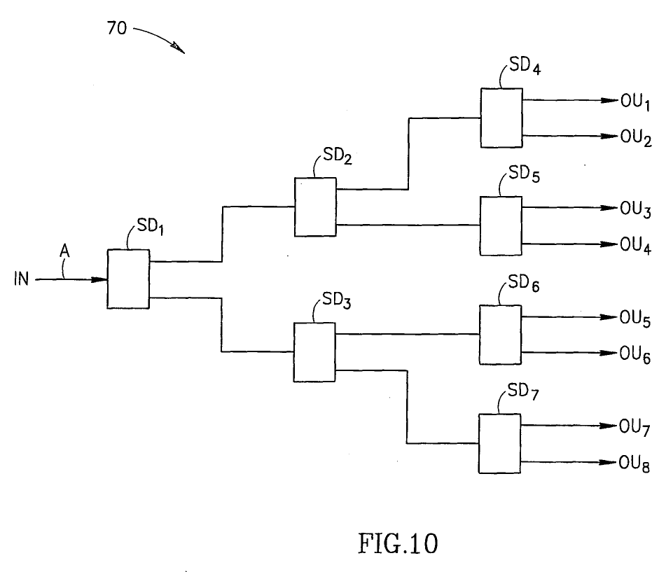

FIG. 10 illustrates an optical system 70 operating as a clock distributor. The system 70 comprises an array of N 2×2 switch devices with the broadcast feature (the above-described device 52) and arranged in the cascade manner (the so-called “tree-design”) between an input port IN and a plurality of outputs, seven such devices SD₁-SW₇ being shown in the present example connecting the input port IN to eight outputs OU₁-OU₈. The switch devices SD₁-SW₇ are identical, each performing a 0.5/0.5 energy partition (i.e., α=β=0.5). It should, however, be noted that different coefficients could be used, thereby enabling different energy levels at the outputs. Each of the devices SD₂-SW₇ processes a single input, thereby performing a multicast function. The provision of such a cascade of switch devices, results in that input A may be distributed as a broadcast to more than two locations (eight locations in the present example), which may vary in space according to the customer's choice.

If the input signal is a temporal signal representing the clock of the system, it may be distributed to a large variety of additional circuits. The maximal difference Δd between the locations of the various circuits allowable in the system to ensure simultaneous signals arrival at all the locations is connected with the temporal frequency ν of the clock signal (input signal) as follows:

$$ν > \frac{c}{Δ d}$$

wherein c is the light velocity. The maximal difference Δd is determined as follows:

Δd=max{d₁, d₂, . . . , d_{N}}−min{d₁, d₂, . . . , d_{N}}, wherein d₁, d₂, . . . , d_{N} are the length of optical paths of light between the input and the respective one of N outputs.

It should be noted that the same configuration can be used as a spatial array generator setup, in which an input signal A may be any general signal and not specifically the clock.

The above-described setup allows for the distribution of a tree structure in space. It also allows easy expansion of the tree as required.

Spatial Vector-Matrix Multiplier

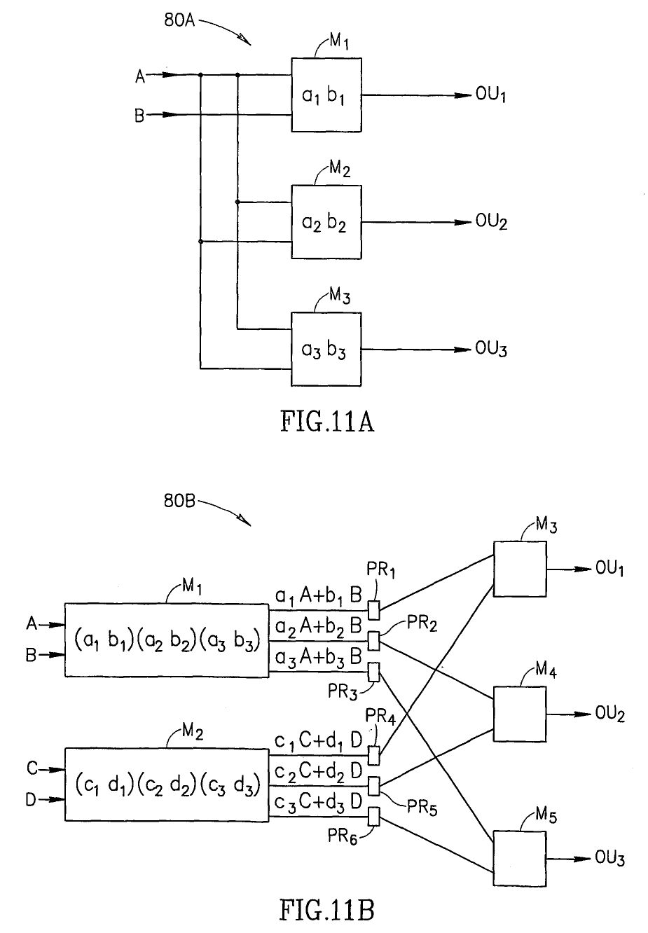

FIGS. 11A and 11B illustrate two examples of the optical implementation of a spatial vector-matrix multiplier, utilizing the broadcast design. In his application, N modules are used, each presenting the above described 2×2 switch device 52, and input is a spatial vector having no more than two signals A and B (pixels).

As shown in the example of FIG. 11A, an optical system 80A comprises three such modules M₁, M₂ and M₃, implementing the “A+B” options with different coefficients a and b, namely, a₁, b₁; a₂, b₂; and a₃, b₃, respectively. Input energy is appropriately supplied to produce input beams A and B simultaneously entering each of the modules M₁, M₂ and M₃, for example, by using the above described clock distributor. Three outputs OU₁, OU₂ and OU₃ of the modules M₁, M₂ and M₃, respectively, present the following sums: (a₁A+b₁B), (a₂A+b₂B), and (a₃A+b₃B). Thus, the obtained three outputs realize a 1×2 vector with 2×3 matrix multiplication:

$$[ \begin{matrix}A & B\end{matrix} ] \times [ \begin{matrix}{a}_{1} & {a}_{2} & {a}_{3} \\ {b}_{1} & {b}_{2} & {b}_{3}\end{matrix} ] = ( {a}_{1} A + {b}_{1} B , {a}_{2} A + {b}_{2} B , {a}_{3} A + {b}_{3} B )$$

In order to save hardware, the vector-matrix operation can be conducted in series (and not in parallel as exemplified in FIG. 11A), by transferring each the output signals (e.g., (a₁A+b₁B)) to three different registers or other appropriate detector combined with registers (not shown), which records, or detects and records, the signals. By this, the multiplication is conducted sequentially in three cycles.

In the more general case for N outputs, a 1×2 with 2×N vector with matrix multiplication can be obtained:

$$[ \begin{matrix}A & B\end{matrix} ] \times [ \begin{matrix}{a}_{1} & {a}_{2} & … & {a}_{N - 1} & {a}_{N} \\ {b}_{1} & {b}_{2} & … & {b}_{N - 1} & {b}_{N}\end{matrix} ]$$

FIG. 11B exemplifies a system 80B presenting an even more general vector with matrix multiplication. Here, five modules (switch devices) M₁-M₅ are used, wherein modules M₁ and M₂ are devices similar to the above-described device 80A, and modules M₃-M₅ perform the “A+B” option with coefficients α=β=1.

Pairs of signals A and B are sequentially supplied to module M₁, and coefficient pairs are controlled to be sequentially set to (a₁, b₁), (a₂, b₂), and (a₃, b₃). Sequentially supplied to M₂ are pairs of signals C and D, and this module is sequentially operated to provide coefficients (c₁, d₁), (c₂, d₂), and (c₃, d₃). Sequentially produced outputs of module M₁ are: (a₁A+b₁B), (a₂A+b₂B) and (a₃A+b₃B), and sequentially produced outputs of module M₂ are: (c₁C+d₁D), (c₂C+d₂D) and (c₃C+d₃D). Hence, each of modules M₁ and M₂ realize a 1×2 vector with 2×3 matrix multiplication.

The time schedule of supplying the pairs of input signals A-B and C-D is such that outputs (a₁A+b₁B) and (c₁C+d₁D) simultaneously enter the module M₃, outputs (a₂A+b₂B) and (c₂C+d₂D) simultaneously enter module M₄, and outputs (a₃A+b₃B) and (c₃C+d₃D) simultaneously enter module M₅. By this, the following outputs of the entire system are provided: OU₁=(a₁A+b₁B+c₁C+d₁D), OU₂=(a₂A+b₂B+c₂C+d₂D), and OU₃=(a₃A+b₃B+c₃C+d₃D). Thus, the so obtained three outputs realize a 1×2 vector with 4×3 matrix multiplication.

Hence, for the more general case we have:

$$[ \begin{matrix}A & B & C & D\end{matrix} ] \times [ \begin{matrix}{a}_{1} & {a}_{2} & … & {a}_{N - 1} & {a}_{N} \\ {b}_{1} & {b}_{2} & … & {b}_{N - 1} & {b}_{N} \\ {c}_{1} & {c}_{2} & … & {c}_{N - 1} & {c}_{N} \\ {d}_{1} & {d}_{2} & … & {d}_{N - 1} & {d}_{N}\end{matrix} ]$$

As further shown in FIG. 11B, polarization rotators with polarizers sets PR₁, PR₂ and PR₃ may be accommodated in the optical path of three outputs, respectively, of module M₁, and three polarization rotators with polarizers sets PR₄, PR₅ and PR6 may be accommodated in the optical path of three outputs, respectively, of module M₂. The provision of such polarization rotators with polarizers sets is optional and is associated with the following:

Generally, the case may be such that an 1×M with M×N multiplication should be obtained. Implementing M sets of previously discussed modules results in M 1×2 with 2×N vector with matrix multiplication. In order to obtain the required result, a summation is necessary. The main problem is that the output polarization of each one of the M sets is not known. This problem can be overcome by placing constant 45-degree polarization rotators followed by a linear polarizer, thereby enabling to obtain the known polarization. This, however, will cause a 50% energy loss. The output is divided into couples and each one of them is insert again to the “A+B” module. This procedure is repeated until a single signal output of the M components is achieved. Each step cost is additional 50% energy loss. The resulted output is a 1×N spatial vector. For M=2^{K}, the number of required steps is (K−1), and the energy loss is (0.5)^{K-1} (the first stage does not cost any energy loss). This procedure is required only in the case of polarization-sensitive switches.

According to another embodiment, modules M₁ and M₂ can be realized in a manner similar to the above-described system 80A, thus enabling to optically process the vector-matrix multiplication in parallel and to enhance computation speed. Such an embodiment also facilitates the management of modules M₃-M₅, whereby they can accept as input any output signals of the module M₁ or M₂ and not only the output resulted from the same input signals fed to the system 80B in the same time cycle.

Add Drop Multiplexer

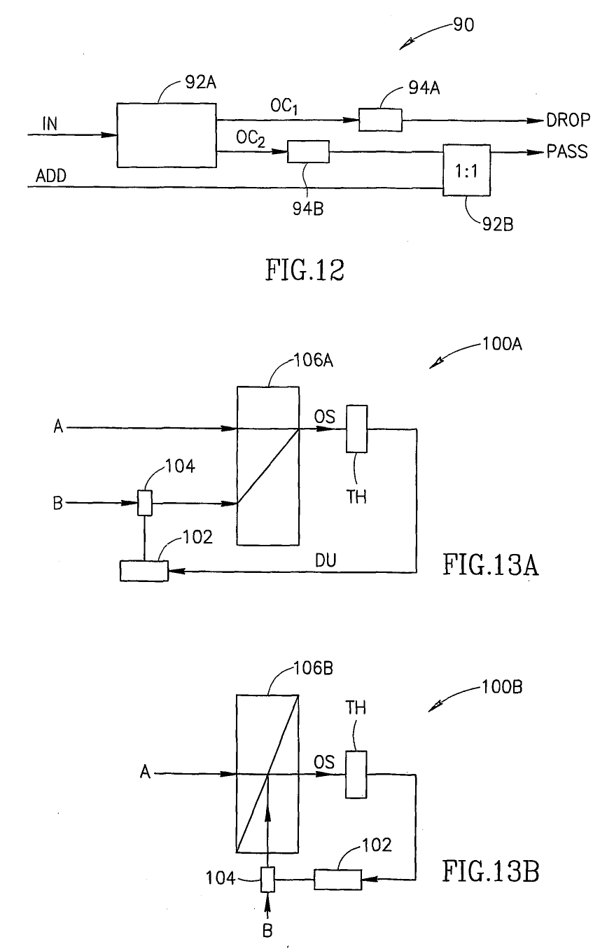

FIG. 12 illustrates an optical system 90 operating as an add drop multiplexer. The system 90 comprises two switch devices 92A and 92B (each constructed and operated as the above described switch device 52), and two frequency or code filters 94A and 94B, which are installed in the optical paths of light ensuing from the device 92A at two output channels OC₁ and OC₂ thereof, respectively. The switch device 92A performs a multicast function, e.g., 10% and 90% of the input energy are, respectively, conveyed towards output channels OC₁ and OC₂. The switch device 92B is accommodated at the output of the filter 94B, two inputs of the device 92B being the output OC₂ filtered by filter 94B and a signal supplied from an add channel. The filter device 94A picks up a certain wavelength from the multiple-wavelength output OC₁ and allows its propagation along a drop channel, while filtering out all other wavelengths. Additional amplifiers or attenuators can be added if needed. Filter 94B filters the output OC₂ so as to filter out only this certain wavelength, and allow all other wavelengths to propagate to the switch device 92B.

A temporal input data IN is inserted, being transmitted in the Wavelength Division Multiplexing (WDM) or the Code Division Multiplexing (CDMA) coding, and not the Time Division Multiplexing (TDMA). According to WDM, each user has its own wavelength band. According to CDMA, all the users are spread over the entire spectrum, as well as the time slot, and they may be distinguished due to special code uniquely adapted to each one of them. Hence, in the present example, it is assumed that the information of various users is spread over the entire temporal slot. The add option of the add/drop multiplexer is obtained using the “A+B” option of the switch device 92A. The dropping is implemented with the broadcast option that allows to both forward the information and filter the desired user's data out of the stream (since the input stream is replicated twice). The filtering is realized using a special wavelength or code division in fiber filters adapted for this use (such as Bragg gratings). It should be noted that, in the broadcast option (when the “A+B” option is realized by a free space-based switch such as the device 12 in FIG. 5), changing the retardation degree allows to control the energetic ratios exhibited between the split output locations.

Adaptive Analog-to-Digital (AID) Converter

FIGS. 13A and 13B illustrate two optical systems 100A and 100B, respectively, presenting two different implementations of an adaptive A/D converter. Each of the systems 100A and 100B utilizes a polarizing splitting element that performs the “A+B” option, which is used here to carry out A/D conversion. This is implemented by adding an input signal A to another constant input signal B (logical signal) to obtain an output signal OS in the form of a sum (A+αB). This output arrives at a threshold utility TH where it is compared with a constant threshold, whose output may be “1” or “0”, to thereby obtain a digital output DU received at a digital control utility 102. The coefficient a is varied with time using an attenuator 104, until the sum A+αB it larger than the TH (then α is proportional to the input energy in beam A). Eventually the A/D operation is obtained. In the example of FIG. 13A, the polarizing splitting element 106A is a calcite crystal, and in the system 100B of FIG. 13B, the polarizing splitting element 106A is a beam splitter.

Miniature Interferometer and Image Subtractor

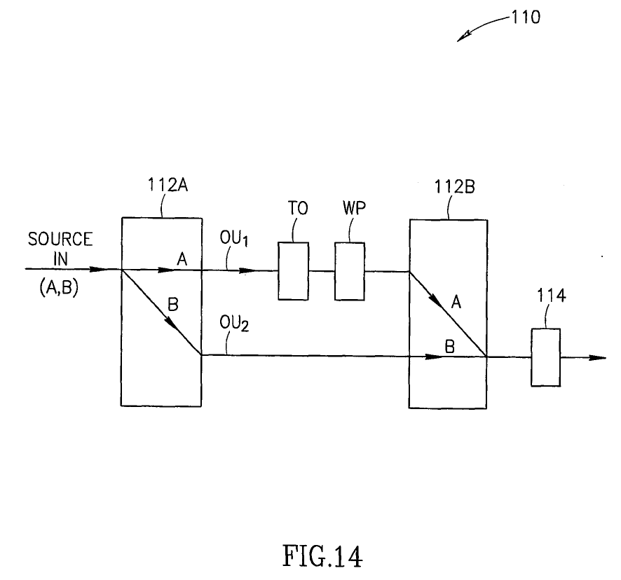

FIG. 14 illustrates an optical system 110 operating as an interferometer. The system comprises two polarizing splitting elements 112A and 112B (calcite crystals in the present example), where element 112B is preceded by a half lambda plate WP, and a 45-degree polarizer 114 at the output of the element 112B. An input signal IN is generated by a source. A test object TO is located at one output OU₁ of the element 112A, thereby affecting this output signal, namely introducing a certain phase delay.

It is assumed here that light components A and B of the input signal IN are produced by mutually coherent light sources (the same source). It should be understood that, in the output plane, the A-component of “A+B” is obtained with polarization different from the polarization of the B-component. To this end, the polarizer 114 rotated 45 degrees is used to extract the interfering signals out of the A- and B-components.

The interferometer 110 is thus compact and robust. By changing the angle of the polarizer or the coefficients a and b in the (aA+bB) expression, the effect of the phase shift introduced by the test object can be extracted.

It should be noted, although not specifically shown, that a similar device may be used for image subtraction. This is implemented by utilizing the option “A+(−B)”, is wherein the (−B) signal is obtained by adding a π-phase shifter plate to the B-component of the input signal.

Those skilled in the art will readily appreciate that various modifications and changes may be applied to the embodiments of the invention as hereinbefore exemplified without departing from its scope defined in and by the appended claims.

1. An optical method of performing at least one of the following functions: logical operations, clock distribution, add drop multiplexing, and vector-matrix multiplying, the method comprising passage of at least one input signal through a predetermined number of 2×2 broadcast switch devices, each operable to perform polarization encoding of light passing therethrough and comprising a controllable polarization rotating medium operable to provide a predetermined energy partition of two beam components passing therethrough, to thereby obtain an output signal of the switch device in the form of a sum of energies of the two beam components according to the predetermined energy partition.

2. The method according to claim 1, for selectively realizing one of the following logical gates: OR, AND, NAND, and NOR, wherein one or two input beams are selectively supplied to the switch device, and the output of the switch device passes through a thresolding utility preprogrammed to a certain threshold value in accordance with the logical gate to be realized.

3. The method according to claim 1, for performing the neural network logical operation, wherein
M input signals supplied from N couplers are appropriately coupled to the switch devices, a plurality of the output signals being produced, each of said output signals being a sum of energies of all the inputs according to the predetermined energy partitions of the respective nodes;
said plurality of the output signals are directed to a plurality of thresholding utilities, respectively, each of said thresholding utilities being preprogrammed to a certain threshold value to thereby selectively allow collection of the respective output signal at an output port.

4. The method according to claim 1, for performing the clock distribution of the input signal to a predetermined number N of locations by passing the input signal along N various circuits, wherein:
the input signal passes through the switch devices arranged in a tree-like cascade manner enabling multiple switching stages defining said N various circuits;
selecting a frequency ν of said input signal to satisfy a relationship ν>(c/Δd), wherein c is the light velocity, and Δd is a maximal difference between locations of said circuits enabling simultaneous arrival of the input signal at said N locations, and is determined as follows: Δd=max{d₁, d₂, . . . , d_{N}}−min{d₁, d₂, . . . , d_{N}}, wherein d₁, d₂, . . . , d_{N} are lengths of the N circuits;

5. The method according to claim 1 for performing the add drop multiplexing, wherein:
the input signal, which is a multiple wavelength signal, passes through a first switch device producing first and second output signals with a predetermined energy partition therein propagating along two output channels of the first switch device;
the first and second output signals of the first switch device pass through, respectively, first and second frequency filters producing first and second filtered signals, the first filtered signal propagating towards a drop channel;
the second filtered signal and a signal supplied from an add channel pass through a second switch device producing an output signal propagating towards a pass channel.

6. The method according to claim 1, for performing the vector matrix multiplying operation, wherein
said input signal is a spatial vector having no more than two signals A and B;
said input is simultaneously coupled to N modules, each including said switch device, thereby obtaining a 1×2 with 2×N vector with matrix multiplication:
$$[ \begin{matrix}A & B\end{matrix} ] \times [ \begin{matrix}{a}_{1} & {a}_{2} & … & {a}_{N - 1} & {a}_{N} \\ {b}_{1} & {b}_{2} & … & {b}_{N - 1} & {b}_{N}\end{matrix} ] = ( {a}_{1} A + {b}_{1} B , {a}_{2} A + {b}_{2} B , … , {a}_{N} A + {b}_{N} B )$$
wherein a₁ and b₁; a₂ and b₂; . . . ; a_{N} and b_{N} are pairs of coefficients defining the energy partitions of N modules, respectively.

7. The method according to claim 7, wherein the input beam passes through M sets of the N modules, thereby performing M 1×2 with 2×N vector with matrix multiplication.

8. An optical method for performing interferometric testing of an object, the method comprising the steps of:
locating the object to be tested at one of two output channels of a first birefringent element;
passing an input beam through said first birefringent element, the input beam containing two coherent beam components of different linear polarizations, thereby producing two spatially separated output beams of different linear polarizations propagating along the two output channels of the first birefringent element, one of said two output beams passing through said object;
passing the two output beams of the first birefringent element through a second birefringent element, thereby producing a combined output beam having one component affected by said object, said combined output beam thereby presenting an interference pattern of the two beams passed through the second birefringent element.

9. An optical method for performing an adaptive analog to digital conversion of an input signal, the method comprising the steps of:
passing the input beam and an attenuated beam through a birefringent medium, thereby producing a combined output beam;
directing the output signal to a thresholding utility preprogrammed to a certain threshold value to thereby generate a corresponding output signal to be received at a control utility.

10. A method for processing two input light beams linearly polarized in the same direction to provide two output beams of random polarization propagating towards two output channels, respectively, the method comprising the steps of:
applying a 90-degree polarization rotation to a beam component of each of the input beams, thereby producing two pairs of beam components, wherein the beam components of each pair have different linear polarizations;
passing the two pairs of beam components through a birefringent medium capable of affecting a direction of propagation of at least one beam component of each pair, thereby obtaining the two output beams of random polarization.

11. A method for connecting two input channels supplying input light beams of random polarization to two output channels for conducting light beams of random polarization, the method comprising the steps of:
passing the input beams through a first birefringent medium capable of affecting the direction of propagation of at least one polarization component of each of the input beams, thereby producing two pairs of beam components, the two beam components in each pair being of different linear polarizations;
passing the beam components through a first polarization rotating means operable to perform 90-degree polarization rotation of one beam component of each pair of beam components, thereby producing two light beams linearly polarized in the same direction;
passing said two light beams linearly polarized in the same direction through a 2×2 switching element operable to perform polarization encoding of light passing therethrough;
passing two light beams linearly polarized in the same direction as output from said 2×2 switch device through a second polarization rotating means operable to perform 90-degree polarization rotation of one beam component of each of said beams; and
passing the beam components, that have passed through said second polarization rotating means, through a second birefringent medium affecting the direction of propagation of at least one polarization component of each of said beams, thereby producing two light beams of random polarization propagating towards said two output channels, respectively.

12. An optical system for performing at least one of the following functions: logical operations, clock distribution, add drop multiplexing, and vector-matrix multiplying, the system comprising a predetermined number of 2×2 broadcast switch devices for passage of an input light beam therethrough, each switch device being operable to perform polarization encoding of light passing therethrough and comprising a controllable polarization rotating medium operable to provide a predetermined energy partition of two beam components passing therethrough, to thereby obtain an output signal of the switch device in the form of a sum of energies of the two beam components according to the predetermined energy partition.

13. The system according to claim 12, further comprising a thresolding utility accommodated in an optical path of the output signal, the thresholding utility being preprogrammed to a certain threshold value in accordance with the logical gate to be realized, the system being thereby capable of selectively performing one of the following logical gates: OR, AND, NAND, and NOR.

14. The system according to claim 12, further comprising:
N couplers for appropriately coupling M input signals to the switch devices producing a plurality of the output signals, each of said output signals being a sum of energies of all the inputs according to the predetermined energy partitions of the respective switch devices; and
a plurality of thresholding utilities accommodated in optical paths of said plurality of the output signals, respectively, each of said thresholding utilities being preprogrammed to a certain threshold value to thereby selectively allow collection of the respective output signal at an output port, the system being thereby capable of performing the neural network logical operation.

15. The system according to claim 12, wherein the switch devices are arranged in a tree-like cascade manner enabling multiple switching stages of the input signal defining N various circuits connecting the input signal to N locations, respectively, a frequency ν of said input signal being selected to satisfy a relationship ν>(c/Δd), wherein c is the light velocity, and Δd is a maximal difference between locations of said circuits enabling simultaneous arrival of the input signal at said N locations, and is determined as follows: Δd=max{d₁, d₂, . . . , d_{N}}−min{d₁, d₂, . . . , d_{N}}, wherein d₁, d₂, . . . , d_{N} are lengths of the N circuits, the system being thereby capable of performing the clock distribution.

16. The system according to claim 12, further comprising first and second frequency filters accommodated at first and second output channels, respectively of a first switch device, wherein:
the input signal is a multiple wavelength signal passing through the first switch device,
an output of the first frequency filter propagates towards a drop channel;
an output of the second frequency filter and an additional input signal from an add channel present two inputs, respectively of a second switch device, the output signal of the second switch device propagating towards a pass channel;
the system being thereby capable of performing add drop multiplexing.

17. The system according to claim 12, wherein N switch devices are simultaneously coupled to the input signal, which is a spatial vector having no more than two signals A and B, the N switch devices being are characterized by pairs of coefficients a₁ and b₁; a₂ and b₂; . . . ; a_{N} and b_{N}, respectively, defining the energy partitions of N switch devices, the system being thereby capable of performing a 1×2 with 2×N vector with matrix multiplication:
$$[ \begin{matrix}A & B\end{matrix} ] \times [ \begin{matrix}{a}_{1} & {a}_{2} & … & {a}_{N - 1} & {a}_{N} \\ {b}_{1} & {b}_{2} & … & {b}_{N - 1} & {b}_{N}\end{matrix} ] = ( {a}_{1} A + {b}_{1} B , {a}_{2} A + {b}_{2} B , … , {a}_{N} A + {b}_{N} B )$$

18. The system according to claim 17, further comprising M sets of the N switch devices, and being thereby capable of performing M 1×2 with 2×N vector with matrix multiplication.

19. An optical system for performing interferometric testing of an object, the system comprising:
a first birefringent element spatially separating two coherent beam components of different linear polarizations of an input beam to thereby produce first and second spatially separated output signals of different linear polarizations, the object being located in an optical path of the first output signal to thereby affect said first output signal;
a second birefringent element accommodated in optical paths of the first affected output signal and the second output signal to thereby produce a combined output beam having one component affected by said object, said combined output beam thereby presenting an interference pattern of the two beams passed through the second birefringent element.

20. An optical system for performing an adaptive analog to digital conversion of an input signal, the system comprising:
a birefringent medium for combining the input beam with an attenuated beam to thereby produce a combined output beam;
a thresholding utility accommodated in an optical path of said combined output beam, the thresholding utility being preprogrammed to a certain threshold value to generate a corresponding output signal; and
a digital control utility for receiving said output signal and generating a digital signal indicative of said input light signal.

21. An optical device for processing two input light beams linearly polarized in the same direction to provide two output beams of random polarization propagating towards two output channels, respectively, the device comprising:
means for spatially separating each of the input beams into a pair of beam components;
a polarization rotating means performing a 90-degree polarization rotation of one beam component of each pair; and
a birefringent medium affecting the direction of propagation of at least one beam component of each pair.

22. The device according to claim 22, wherein the means for spatial separation of each of the input beams and the polarization rotating means are incorporated in a common ferroelectric liquid crystal unit defining an array of separately controllable cells.

23. A switch device for connecting two input signals of random polarization to two output channels conducting light of random polarization, the device comprising:
a first birefringent medium accommodated in optical paths of said input signals to thereby divide each of the input signals into a pair of spatially separated beam components of different linear polarizations;
a first controllable polarization rotating medium accommodated in the optical path of the two pairs of beam components, and operable to rotate the polarization of one beam component in each pair to thereby produce two beams linearly polarized in the same direction;
a 2×2 switching element accommodated in optical paths of said two beams linearly polarized in the same direction, the switching element being operable to perform polarization encoding of light passing therethrough;
a second controllable polarization rotating medium accommodated in optical path of two beams linearly polarized in the same direction as output from the switching element, the second controllable polarization rotating medium being operable to spatially separate each of the incident beams into two beam components and rotate the polarization of one of the beam components of each beam; and
a second birefringent medium accommodated in optical paths of the beam components passed through the second polarization rotating medium, to thereby produce output beams of random polarization propagating towards said output channels.
